(19) United States
(12) Patent Application Publication
(10) Pub. No.: US 2020/0318774 A1
(43) Pub. Date: Oct. 8, 2020

(54) Local repair method combining internally bonded CFRP and polymer grouting for cracks in drainage pipe

(71) Applicants: Infrastructure Renewal Insitute of Southern China, Huizhou (CN); WELEAD Infrastructure Engineering Technology (Zhengzhou), Ltd.

(72) Inventors: Fuming Wang, Huizhou (CN); Hongyuan Fang, Huizhou (CN); Peng Zhao, Zhengzhou (CN); Yanhui Pan, Zhengzhou (CN); Bin Li, Zhengzhou (CN); Hang He, Zhengzhou (CN)

(21) Appl. No.: 16/897,992

(22) Filed: Jun. 10, 2020

(30) Foreign Application Priority Data
Sep. 25, 2019 (CN) 201910912149.X

(51) Int. Cl. F16L 55/175; F16L 55/134

(52) U.S. Cl. CPC F16L 55/175; F16L 55/134

(57) ABSTRACT

A local sealing structure for cracks on a drainage pipe, includes: a first repair material, a second repair material, a cover layer, a reinforcement body and a joint filler; wherein: the joint filler is configured to fill and seal cracks on a pipeline; the reinforcement body is configured to reinforce soil outside the pipeline; the first repair material is configured to seal the cracks; the second repair material is configured to adhere a surface of the first repair material; and the cover layer is configured to seal a surface of the second repair material; wherein a joint offset distance between the first repair material and the second repair material is greater than or equal to a third predetermined distance. A local repair method for cracking of a large-diameter concrete drainage pipe is further provided.

### CROSS REFERENCE OF RELATED APPLICATION

The present application claims priority under 35 U.S.C. 119(a-d) to CN 201910912149.X, filed Sep. 25, 2019.

### BACKGROUND OF THE PRESENT INVENTION

### Field of Invention

The present invention relates to the field of crack repair of concrete drainage pipes, and more particular to a local repair method combining internally bonded CFRP (Carbon Fiber Reinforced Polymer/Plastic) and polymer grouting for cracks in the drainage pipe.

### Description of Related Arts

The urban underground pipeline network is an important infrastructure of the city, and it is the “underground lifeline” that guarantees the normal operation and operation of the overall urban functions. With the rapid development of urbanization in China, the quantity of urban underground pipeline expansion and reconstruction is increasing. At present, the total length of various types of pipelines in China is already very large. However, due to the early construction process, poor pipeline materials, and inadequate maintenance and the long-term operation, the concrete drainage pipes often suffer from cracks, leakage and other local diseases under the influence of complex environmental load factors. If not repaired in time, it will not only cause urban road collapse, environmental pollution and other accidents, but also the leakage of sewage in the pipe will affect the surrounding soil environment. Meanwhile, it also will affect residents' travel Safety and living environment, causing a certain degree of damage to road traffic and urban economy. Therefore, timely and effective measures should be taken to prevent cracks and damage to the underground drainage pipe network to avoid greater losses.

The current repair schemes for cracks in underground drainage pipe networks mainly include two categories: the first category is the method of excavation and replacement of new pipes. It can cure the disease, but the construction speed is slow, the traffic environment is greatly affected, the cost is high, a lot of construction waste is produced, the environment is polluted and the pipe network is to stop running, the financial and material resources are consumed greatly, and the life of urban residents is also affected. The second type is the method of non-excavation repairs, which generally include pipeline interpolation and new cement mortar Lining method, newly established epoxy resin lining method, slip-lined hose method, small-diameter pipe insertion method, lining steel plate reinforcement method, and CIPP in-situ curing method. Although these methods can solve the problem of pipeline leakage, there are some limitations and deficiencies in the plan. Some only realize the function of anti-seepage and cannot reinforce the pipeline. In addition, some have complicated processes and strict requirements on the construction conditions.

The patent document with the application number 201810540436.8 discloses a polymer grouting construction process, but only discloses the general use method of grouting, which cannot achieve sealing repair of pipeline cracks. Therefore, it is necessary to study a new type of non-excavated crack repair technology for drainage pipeline.

### SUMMARY OF THE PRESENT INVENTION

In view of the above-mentioned shortcomings of the prior art, an object of the present invention is to provide a local repair method combining internally bonded CFRP and polymer grouting for cracks in the drainage pipe. The pipe crack can be sealed and repaired in the interior using a non-excavation, sealed means to repair cracks in drainage pipes.

In order to achieve the above object, the present invention adopts the following technical solutions.

A local sealing structure for cracks on a drainage pipe, comprises: a first repair material, a second repair material, a cover layer, a reinforcement body and a joint filler; wherein:

the joint filler is configured to fill and seal cracks on a pipeline;

the reinforcement body is configured to reinforce soil outside the pipeline;

the first repair material is configured to seal the cracks;

the second repair material is configured to adhere a surface of the first repair material; and

the cover layer is configured to seal a surface of the second repair material;

wherein a joint offset distance between the first repair material and the second repair material is greater than or equal to a third predetermined distance.

Preferably, the joint filler is formed by solidifying a first slurry; the reinforcement body is formed by solidifying a second slurry; and the cover layer is formed by drying a cover material with air.

Preferably, the first slurry is a quick-setting polymer repair material; the second slurry is a polymer repair material;

the first repairing material and the second repairing material are CFRP fiber cloths impregnated with impregnating compound; and

the cover material is epoxy resin.

The present invention provides a sealing method for the sealing structure, as recited in claim 1, comprises steps of:

T1: performing a first grouting on an external of the pipeline through a first grouting tool, injecting the first slurry, and sealing the cracks;

T2: performing a second grouting on the external of the pipeline through a second grouting tool, injecting the second slurry, and reinforcing soil outside the pipeline;

T3: after sealing the cracks is completed and the second slurry permeates and consolidates, polishing an internal wall of the pipeline at a crack location, and evenly coating primer adjusted on a surface of the internal wall of the pipeline at the crack location;

T4: after the primer is dried, pasting the first repair material on a surface of the primer;

T5: after the first repair material is cured, pasting the second repair material on a surface of the first repair material; and

T6: after the second repair material is consolidated, constructing the cover layer on a surface of the second repair material.

Preferably, the first grouting tool is a portable grouting device

Preferably, the second grouting tool is a polymer grouting device.

Furthermore, the present invention provides a method for locally repairing cracks on a drainage pipe, comprises the sealing method as recite in claim 4, and further comprising steps of:

S1: checking the pipeline and finding out the crack location of the pipeline;

S2: blocking the upstream water, and cleaning an internal wall of the pipeline at the crack location;

S3: providing a plurality of grouting holes on both sides of the crack location, wherein the grouting holes penetrate a pipe wall of the pipeline, and a grouting pipe is inserted into the grouting holes to perform the sealing method.

Preferably, in the step S1, checking the pipeline specifically comprises: putting a pontoon equipped with a camera system into the pipeline by an inspection well, and photographing an upper pipe wall on a water surface of the pipeline by the camera system.

Preferably, in step S2, a tool for blocking the upstream water is a water shut-off airbag, and an external tube compressor is adopted to inflate the water shut-off airbag; a tool for the cleaning is a high-pressure water flow device.

Preferably, in step S3, point drilling is taken at a first predetermined distance on both sides of the crack, and a hole spacing between adjacent grouting holes is a second predetermined distance.

Compared with the prior art, the present invention provides a local repair method combining internally bonded CFRP and polymer grouting for cracks in the drainage pipe. The sealing structure reinforces the surrounding soil at the crack of the pipeline to stabilize the soil, and then seals the crack, which can be repaired to form a solid pipeline crack lining repair structure, which can repair cracks quickly, with fast construction speed and low impact on the environment.

### BRIEF DESCRIPTION OF THE DRAWINGS

FIG. 1 is a flowchart of a method for partially repairing a crack in a large-diameter concrete drainage pipe provided by the present invention.

FIG. 2 is a schematic perspective view of a pipe with a crack provided by the present invention.

FIG. 3 is a schematic sectional view of a pipe with a crack provided along the longitudinal direction of the crack provided by the present invention.

FIG. 4 is a schematic longitudinal sectional view of a crack detected by a pontoon provided by the present invention.

FIG. 5 is a perspective view of a pipe drilled with grouting holes provided by the present invention.

FIG. 6 is a schematic longitudinal sectional view of a pipe drilled with grouting holes provided by the present invention.

FIG. 7 is a schematic longitudinal sectional view of a pipe to which a first repair material and a second repair material applied according to the present invention.

FIG. 8 is a schematic diagram of a longitudinal structure of a pipe to which a first repair material and a second repair material applied according to the present invention.

FIG. 9 is a schematic diagram of a lateral structure of a pipe to which a first repair material and a second repair material applied according to the present invention.

### CFRP (CARBON FIBER REINFORCED POLYMER/PLASTIC)

### Detailed Description of the Preferred Embodiment

In order to make the purpose, technical solution, and effect of the present invention more clear and specific, the present invention is further described in detail below with reference to the accompanying drawings and embodiments. It should be understood that the specific embodiments described herein are only used to explain the present invention and are not intended to limit the present invention.

### Example 1

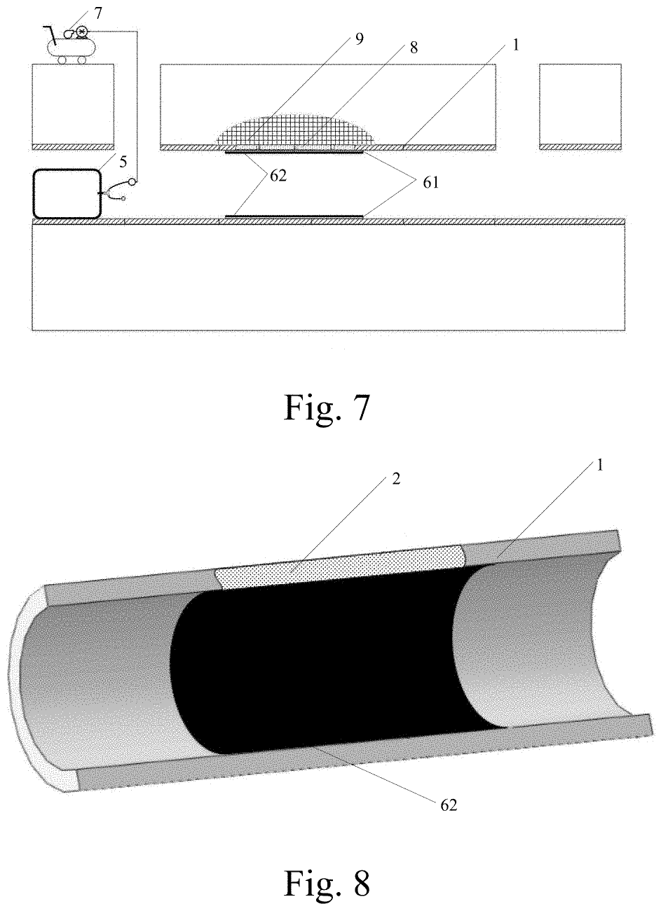

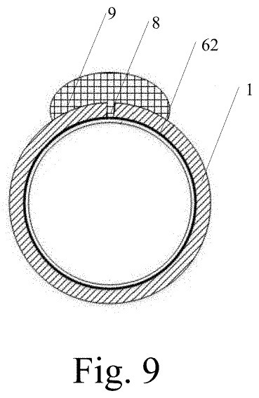

Please refer to FIGS. 7-9 together. The present invention provides a cracked partial sealing structure for a drainage pipe, which includes: a first repair material 61, a second repair material 62, a cover layer (not shown), a solid body 9 and a filler Slit body 8;

The caulk body 8 is configured to fill and block cracks on the pipeline;

The added solid 9 is configured to reinforce the soil outside the pipeline;

The first repair material 61 is configured to seal the crack;

The second repair material 62 is configured to be adhered to a surface of the first repair material 61;

The cover layer is configured to seal the surface of the second repair material 62;

The offset distance between the seams of the first repair material 62 and the second repair material 61 is greater than or equal to a third predetermined distance.

As a preferred solution, the caulk body is formed after the first slurry is solidified; the added solid is formed after the second slurry is solidified; and the cover layer is formed after the cover material is air-dried.

Specifically, the sealing structure provided by the present invention has a solidified body 9 outside the pipeline 1 for supporting and reinforcing the eroded soil body, and has the plugging body 8 plugged in the crack 2 and uses the first repairing material 61 is sealed at the position of the crack 2 of the pipe 1, and then the second repairing material 62 is used to adhere to the surface of the first repairing material 61 to form an excellent sealing structure that supports the soil.

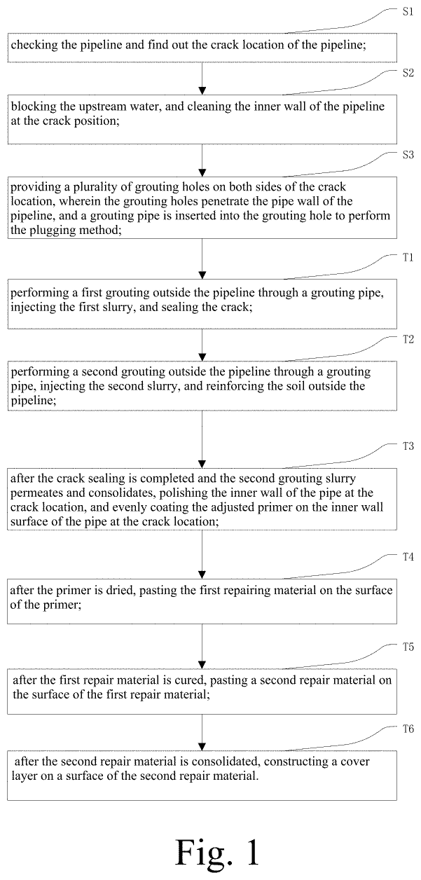

As a preferred solution, please refer to FIG. 1 in detail. The sealing structure is constructed using the sealing method provided by the present invention, and includes steps:

T1: performing the first grouting to the outside of the pipeline 1 through the grouting pipe 3, injecting the first slurry, and sealing the crack 2;

T2: perform a second grouting outside the pipeline 1 through a grouting pipe 3, inject the second slurry, and reinforce the soil outside the pipeline 1;

T3: after the sealing of the crack 2 is completed and the slurry of the second grouting permeates and consolidates, polish the inner wall of the pipe at the position of the crack 2 and evenly coat the adjusted primer to the pipe at the position of the crack. Inner wall surface

T4: After the primer is dried, paste the first repair material 61 on the surface of the primer;

T5: After the first repair material 61 is cured, a second repair material 62 is pasted on the surface of the first repair material 61;

T6: After the second repair material 62 is consolidated, the cover layer is constructed on the surface of the second repair material 62.

Please refer to FIGS. 7-9. As a preferred solution, in this embodiment, in the step S4, the slurry for the first grouting is a quick-setting polymer repair material; the tool for the first grouting For portable grouting equipment.

As a preferred solution, in this embodiment, in step S5, the slurry for the second grouting is a polymer repair material; and the tool for the second grouting is a polymer grouting device.

Specifically, the grouting process of the present invention is divided into two parts, and the purpose of injecting the first slurry is to quickly seal the crack 2. Therefore, the material used is a fast-setting polymer, preferably a double-sizing fast-setting type Polymer, such as AB glue; the portable grouting device is a common portable grouting device on the market. The purpose of injecting the second slurry is to strengthen the soil outside the pipeline 1 for reinforcement, and the polymer has extremely strong compressive performance to prevent soil collapse; the polymer grouting equipment is a grouting equipment that matches the polymer in the art.

As a preferred solution, in this embodiment, the caulking body is formed after the first slurry is solidified; the added solid is formed after the second slurry is solidified; and the cover layer is formed by air-drying the cover material.

The first slurry is a quick-setting polymer repair material;

The second slurry is a polymer repair material;

The first repair material 61 and the second repair material 62 are CFRP fiber cloths impregnated with impregnated rubber;

The cover material is epoxy resin.

Specifically, a first slurry is injected into the outside of the pipe through the grouting pipe, which is used to seal the crack 2 from the outside of the pipe 1, so that the subsequent operations can be performed normally. After the first slurry is solidified, the second slurry is injected into the outside of the pipeline 1 through the grouting pipe to reinforce the soil outside the pipeline 1 to prevent collapse, and the second slurry is observed through the grouting pipe whether to solidify. After the solidification, the crack 2 is sealed and repaired in the pipeline 1.

The completion of the sealing is the consolidation of the first slurry; the completion of the consolidation of the second slurry indicates the completion of the consolidation of the soil outside the pipeline 1, at this time the possibility of collapse of the soil due to a deficit has been eliminated. The grinding tool used is preferably a hand-held polisher. The primer is made by mixing the epoxy resin and the curing agent according to the required ratio and stirring them uniformly. In the repair method provided by the present invention, the crack 2 is sealed and repaired to seal. The repairing process is divided into two steps. The first repairing material 61 and the second repairing material 62 are respectively pasted. The first repairing material 61 and the second repairing material 62 may be the same or different.

Specifically, in this embodiment, the first repairing material 61 is the same as the second repairing material 62, and both are CFRP fiber cloth, preferably a carbon fiber cloth CFRP material; the CFRP fiber cloth must be soaked during use. Over dipping glue.

The third predetermined distance is 50 mm, and the effect of staggering the seam between the first repair material and the second repair material is to expand the coverage and achieve the best sealing effect.

### Example 2

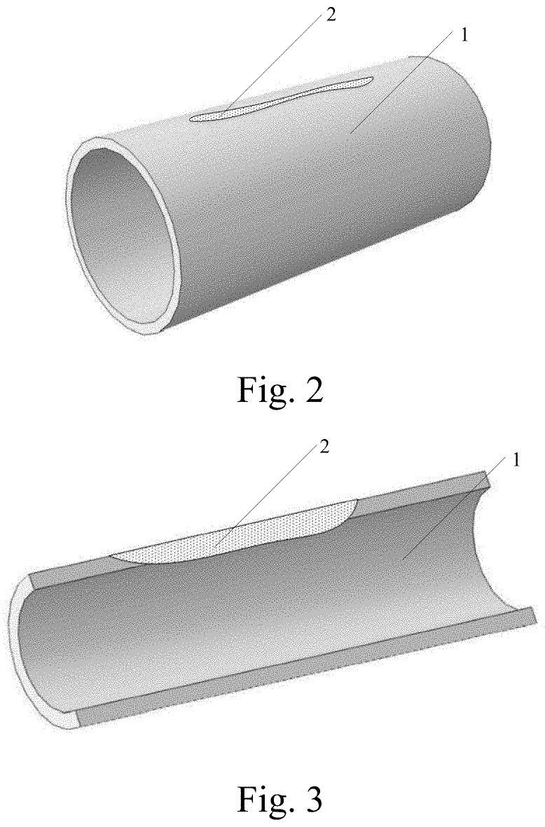

Please refer to FIG. 1 to FIG. 3 and FIG. 5 to FIG. 6 together. The present invention provides a method for partially repairing cracks in a drainage pipe, including the steps:

S1. checking pipeline 1 and find out the location of pipeline crack 2;

S2. blocking upstream water, and cleaning the inner wall of the pipeline at the crack 2;

S3. providing a plurality of grouting holes 3 on both sides of the position of the crack 2; wherein the grouting holes 3 penetrate the pipe wall of the pipeline 1, and a grouting pipe is inserted into the grouting hole 3 to execute the grouting hole.

Specifically, it is necessary to use equipment to inspect the pipeline 1 and find out the specific location of fracture 2, and then the upper end of the nearest detection well upstream from the location of fracture 2 will be blocked by water in the future. After sealing the water, cleaning the inner wall of the pipeline at the crack 2 position, removing the silt and sand impurities, so as to facilitate the subsequent treatment After cleaning, grout holes 3 are arranged on both sides of the position of the crack 2 and the number depends on the length of the crack 2. The purpose of opening the grouting hole 3 is to grout the first slurry and the second slurry of the soaked soil outside the pipe 1, so the grouting hole 3 should penetrate the pipe wall of the pipe 1. In order to facilitate grouting, the grouting pipe must be inserted into the grouting hole 3, and the grouting pipe is a metal pipe body.

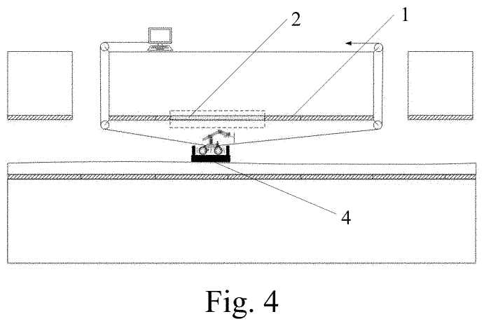

Please refer to FIG. 4. As a preferred solution, in this embodiment, in step S1, the inspection pipeline 1 is specifically:

The inspection well puts a pontoon 4 equipped with a camera system into the pipeline 1, and uses the camera system to photograph the upper pipe wall on the water surface of the pipe.

Specifically, although a large-diameter pipe can be manually inspected, it is most convenient to use a tool when the inside is still running normally. The preferred tool is a pontoon with a camera system, which is equipped with lighting equipment.

Please refer to FIG. 7. As a preferred solution, in this embodiment, in the step S2, the tool for blocking the upstream water comes to a water bladder 5, and an out-of-pipe compressor 7 is used to inflate the water-stop bladder; The cleaning tool is a high-pressure water flow device.

Specifically, in order to facilitate the maintenance personnel to enter the pipeline 1, the upstream incoming water is blocked. In order to adapt to the different diameters of the pipeline 1, the blocking tool is preferably a water bag 5, and the water bag is inflatable. The inflated airbag is inflated with the out-of-tube compressor 7 to inflate the water-stop airbag 5 so that the water-stop airbag 5 is inflated, and the inflated water-stop airbag 5 blocks the upstream water, which can be convenient. The construction space for construction can be carried out without stopping the pipeline operation; when cleaning, the preferred equipment is a high-pressure water flow device, such as a high-pressure water gun.

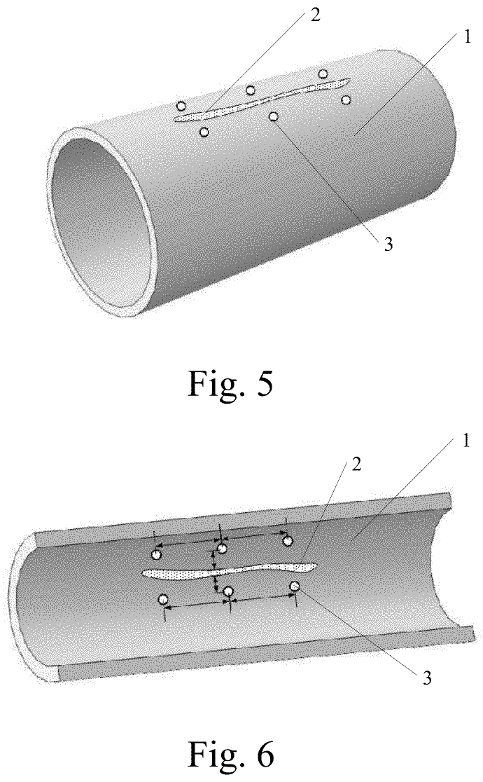

Please refer to FIG. 5 to FIG. 6. As a preferred solution, in this embodiment, in step S3, a point is drilled at a first predetermined distance on both sides of the crack 2, and the second predetermined distance is the distance between adjacent grouting holes 3. The specific number of grouting holes 3 depends on the length of the crack 2. The distance between the hole location of the grouting hole 3 and the crack 2 is the first predetermined distance and it value is preferably 10 cm. The hole distance between the grouting holes 3 is the second distance and its value is 20 cm.

The local repair method for cracking of large-diameter concrete drainage pipelines provided by the present invention is to use polymer grouting to stabilize the soil outside the cracks of the pipeline. The primer mixed with epoxy resin and curing agent is applied on the inner wall of the polished pipeline, and the carbon fiber cloth CFRP soaked with the impregnated adhesive is quickly pasted on the surface of the primer and dried to form a solid crack lining repair structure. The technology does not need excavation, and the repair process is simple. It is a great progress in the field of soil reinforcement outside the pipeline.

It can be understood that for a person of ordinary skill in the art, equivalent replacements or changes can be made according to the technical solution of the present invention and its inventive concept, and all these changes or replacements should fall within the protection scope of the claims attached to the present invention.

What is claimed is:

1. A local sealing structure for cracks on a drainage pipe, comprising: a first repair material, a second repair material, a cover layer, a reinforcement body and a joint filler; wherein:
the joint filler is configured to fill and seal cracks on a pipeline;
the reinforcement body is configured to reinforce soil outside the pipeline;
the first repair material is configured to seal the cracks;
the second repair material is configured to adhere a surface of the first repair material; and
the cover layer is configured to seal a surface of the second repair material;
wherein a joint offset distance between the first repair material and the second repair material is greater than or equal to a third predetermined distance.

2. The local sealing structure for cracks on the drainage pipe, as recited in claim 1, wherein the joint filler is formed by solidifying a first slurry; the reinforcement body is formed by solidifying a second slurry; and the cover layer is formed by drying a cover material with air.

3. The local sealing structure for cracks on the drainage pipe, as recited in claim 2, wherein:
the first slurry is a quick-setting polymer repair material;
the second slurry is a polymer repair material;
the first repairing material and the second repairing material are CFRP fiber cloths impregnated with impregnating compound; and
the cover material is epoxy resin.

4. A sealing method for the sealing structure, as recited in claim 1, comprising steps of:
T1: performing a first grouting on an external of the pipeline through a first grouting tool, injecting the first slurry, and sealing the cracks;
T2: performing a second grouting on the external of the pipeline through a second grouting tool, injecting the second slurry, and reinforcing soil outside the pipeline;
T3: after sealing the cracks is completed and the second slurry permeates and consolidates, polishing an internal wall of the pipeline at a crack location, and evenly coating primer adjusted on a surface of the internal wall of the pipeline at the crack location;
T4: after the primer is dried, pasting the first repair material on a surface of the primer;
T5: after the first repair material is cured, pasting the second repair material on a surface of the first repair material; and
T6: after the second repair material is consolidated, constructing the cover layer on a surface of the second repair material.

5. The sealing method, as recited in claim 4, wherein the first grouting tool is a portable grouting device

6. The sealing method, as recited in claim 4, wherein the second grouting tool is a polymer grouting device.

7. A method for locally repairing cracks on a drainage pipe, comprising the sealing method as recite in claim 4, and further comprising steps of:
S1: checking the pipeline and finding out the crack location of the pipeline;
S2: blocking the upstream water, and cleaning an internal wall of the pipeline at the crack location;
S3: providing a plurality of grouting holes on both sides of the crack location, wherein the grouting holes penetrate a pipe wall of the pipeline, and a grouting pipe is inserted into the grouting holes to perform the sealing method.

8. The method for locally repairing cracks on the drainage pipe, as recite in claim 7, wherein in the step S1, checking the pipeline specifically comprises: putting a pontoon equipped with a camera system into the pipeline by an inspection well, and photographing an upper pipe wall on a water surface of the pipeline by the camera system.

9. The method for locally repairing cracks on the drainage pipe, as recite in claim 7, wherein in step S2, a tool for blocking the upstream water is a water shut-off airbag, and an external tube compressor is adopted to inflate the water shut-off airbag; a tool for the cleaning is a high-pressure water flow device.

10. The method for locally repairing cracks on the drainage pipe, as recite in claim 7, wherein in step S3, point drilling is taken at a first predetermined distance on both sides of the crack, and a hole spacing between adjacent grouting holes is a second predetermined distance.
